(19) United States
(12) Patent Application Publication
(10) Pub. No.: US 2006/0179436 A1
(43) Pub. Date: Aug. 10, 2006

(54) Methods and apparatus for providing a task change application programming interface

(75) Inventor: Masahiro Yasue, Kanagawa (JP)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc.

(21) Appl. No.: 11/261,975

(22) Filed: Oct. 28, 2005

Related U.S. Application Data
(60) Provisional application No. 60/650,749, filed on Feb. 7, 2005.

(51) Int. Cl. G06F 9/46

(52) U.S. Cl. 718/100; 719/328

(57) ABSTRACT

Methods and apparatus provide for executing one or more software programs within a plurality of processors of a multi-processing system in accordance with a data parallel processing model, the software programs being comprised of a number of processing tasks, each task executing instructions on one or more input data units to produce an output data unit, and each data unit containing one or more data objects; responding to one or more application programming interface codes to change from a current processing task to a subsequent processing task within a given one or more of the processors; and using the output data unit produced by the current processor task as an input data unit by the subsequent processing task to produce a further output data unit within the same processor.

### CROSS REFERENCE TO RELATED APPLICATION

This application claims the benefit of U.S. Provisional Patent Application No. 60/650,749, filed Feb. 7, 2005, entitled “Methods And Apparatus For Providing A Task Change Application Programming Interface,” the entire disclosure of which is hereby incorporated by reference.

### BACKGROUND OF THE INVENTION

The present invention relates to methods and apparatus for providing the capability of changing tasks among a plurality of processors in a multi-processing system in response to one or more task change application programming interface (API) codes.

In recent years, there has been an insatiable desire for faster computer processing data throughputs because cutting-edge computer applications are becoming more and more complex, and are placing ever increasing demands on processing systems. Graphics applications are among those that place the highest demands on a processing system because they require such vast numbers of data accesses, data computations, and data manipulations in relatively short periods of time to achieve desirable visual results.

Real-time, multimedia applications are becoming increasingly important. These applications require extremely fast processing speeds, such as many thousands of megabits of data per second. While some processing systems employ a single processor to achieve fast processing speeds, others are implemented utilizing multi-processor architectures. In multi-processor systems, a plurality of sub-processors can operate in parallel (or at least in concert) to achieve desired processing results.

There are two basic processing models to perform a number of processing steps using multiple processors in a parallel multi-processor system: (i) the data parallel processing model; and (ii) the functional parallel processing model. In order to more fully discuss these models, some basic assumptions are considered. An application program (or portion thereof) consists of a plurality of steps (1, 2, 3, 4, . . . ) in which units of data are manipulated in one way or another. These units of data may be designated by Un (e.g., n=1, 2, 3, 4), where Un represents a set of n data objects U1, U2, U3, U4. Thus, in step 1, a data unit Un (U1, U2, U3, U4) may be obtained as a result of processing manipulations of one or more of the n data objects. Assuming some dependency on the data units between steps, in step 2 a data unit Un′ (U1′, U2′, U3′, U4′) may be obtained by manipulating the data unit Un. Similarly, in step 3 a data unit Un″ (U1″, U2″, U3″, U4″) may be obtained by manipulating the data unit Un′. Finally, in Step 4 a data unit Un′″ (U1′″, U2′″, U3′″, U4′″) may be obtained by manipulating the data unit Un″.

Turning again to the basic parallel processing models, in the data parallel processing model, each processor in the multi-processor system performs each of the steps 1-4 sequentially (or according to whatever the data dependency requires). Thus, if there are four processors in the multi-processor system, each processor may perform steps 1-4 on respective ones of the four data sets U1, U2, U3, and U4. In the functional parallel processing model, however, each of the CPU's performs only one of the steps 1-4 and the data units are passed from one CPU to the next in order to achieve the subsequent modified data units according to the data dependency.

The conventional thinking in this art area is that the functional parallel processing model is superior to the data parallel processing model because the latter model would require the ability to change task capabilities within each processor, which would reduce processing throughput. It has been discovered, however, that this conventional thinking is not accurate.

In an ideal system (with no overhead), both the data parallel model and the functional parallel model can achieve 4× faster processing when 4 processors are used as opposed to a single processor. In practical systems, the data parallel model and the functional parallel model exhibit different overhead characteristics and therefore different processing speeds. It has been discovered through experimentation and simulation that, for example, using a “total overhead” analysis, the data parallel model exhibits a 4.65 times lower overhead penalty as compared to the functional parallel model (when the time required to perform two or more of the steps differ significantly). Using an “MFC setup overhead” analysis, the data parallel model exhibits a 1.66 times lower overhead penalty as compared to the functional parallel model. Using a “synchronization overhead” analysis, the data parallel model exhibits a moderately higher overhead penalty as compared to the functional parallel model. This moderately higher penalty, however, is far lower than the overhead penalties of the functional parallel model.

Thus, there is a need in the art for a new approach to achieving the data parallel model in a multi-processor system, which permits a programmer with the ability to achieve task changes within and among the processors of the system using task change application program interface code.

### SUMMARY OF THE INVENTION

In accordance with one or more aspects of the present invention, a multi-processor system is provided with a task change capability to execute the data parallel processing model, where the task change is achieved using application program interface (API) code. In an experiment in which a multi-processor system implemented an MPEG2 codec (where step 1 was variable length decoding (VLD), step 2 was inverse quantization (IQ), step 3 was inverse discrete cosine transform (IDCT), and step 4 was motion compensation (MC), the data parallel model using the task change API coding capability according to aspects of the present invention achieved 3.6 times faster processing using 4 processors as opposed to a single processor system. On the other hand, the functional parallel model implementing the same MPEG2 codec achieved only a 2.9 times faster processing using 4 processors as opposed to a single processor system.

In accordance with at least one aspect of the present invention, methods and apparatus provide for executing one or more software programs within a plurality of processors of a multi-processing system in accordance with a data parallel processing model. The software programs are comprised of a number of processing tasks, each task executing instructions on one or more input data units to produce an output data unit, and each data unit contains one or more data objects. In response to one or more application programming interface codes, a change from a current processing task to a subsequent processing task is invoked within a given one or more of the processors. Further, the output data unit produced by the current processor task is used as an input data unit by the subsequent processing task to produce a further output data unit within the same processor.

The application programming interface codes may be invoked by a software programmer when he designs the one or more software programs such that the plurality of processors implement the data parallel processing model.

Preferably, the software application dictates that the processing tasks are executed repeatedly on different data units to achieve an end result. Certain of the data units are preferably dependent on one or more others of the data units.

Each processor includes a local memory within which to execute the processing tasks without resort to the main memory. In response to the application programming interface code(s), a change from the current processing task to the subsequent processing task is invoked within a given processor while maintaining the output data unit from the current processing task within the local memory of the given processor.

The methods and apparatus may also provide for responding to a request to copy the output data unit from the current processing task to another processor for use as an input data unit for a different processing task.

By way of example, the software program may include M processing tasks for operating on N data units, where M and N are respective integers. In such case, the following steps and/or functions may be carried out in accordance with one or more aspects of the invention: executing a first of the processing tasks on at least a first of the data units to produce a first output data unit therefrom for storage in the local memory of a first of the processors; changing from the first processor task to a second processor task for operating on at least the first output data unit to produce a second output data unit therefrom for storage in the local memory of the first of the processors in response to the application programming interface code(s); and repeating these operations until the M processing tasks have been performed on the first data unit in the first processor.

Various aspects of the present invention may further provide for: executing a first of the processing tasks on at least a second of the data units to produce a first output data unit therefrom for storage in the local memory of a second of the processors, concurrently with the operation of the first processor; changing from the first processor task to the second processor task and operating on at least the first output data unit to produce a second output data unit therefrom for storage in the local memory of the second of the processors in response to the application programming interface code(s); and repeating these operations until the M processing tasks have been performed on the second data unit in the second processor.

Preferably, the M processing tasks are sequentially executed on the data units until all of the M processing tasks have been performed on all of the N data units in one or more of the further processors.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram illustrating the structure of a multi-processing system having two or more sub-processors in accordance with one or more aspects of the present invention;

FIG. 2 is a flow diagram illustrating process steps that may be carried out by the processing system of FIG. 1 in accordance with one or more further aspects of the present invention;

FIG. 3 is a flow diagram illustrating further process steps that may be carried out by the processing system of FIG. 1 in accordance with one or more further aspects of the present invention;

FIG. 4 is a timing diagram illustrating an example of how processing tasks may be executed by the processors of FIG. 1 accordance one or more further aspects of the present invention;

FIG. 5 is a timing diagram illustrating a further example of how processing tasks may be executed by the processors of FIG. 1 accordance one or more further aspects of the present invention;

FIG. 6 is a block diagram illustrating a preferred processor element (PE) that may be used to implement the mutli-processor system in accordance with one or more further aspects of the present invention;

FIG. 7 is a block diagram illustrating the structure of an exemplary sub-processing unit (SPU) of the system of FIG. 6 in accordance with one or more further aspects of the present invention; and

FIG. 8 is a block diagram illustrating the structure of an exemplary processing unit (PU) of the system of FIG. 6 in accordance with one or more further aspects of the present invention.

### DETAILED DESCRIPTION OF THE PRESENT INVENTION

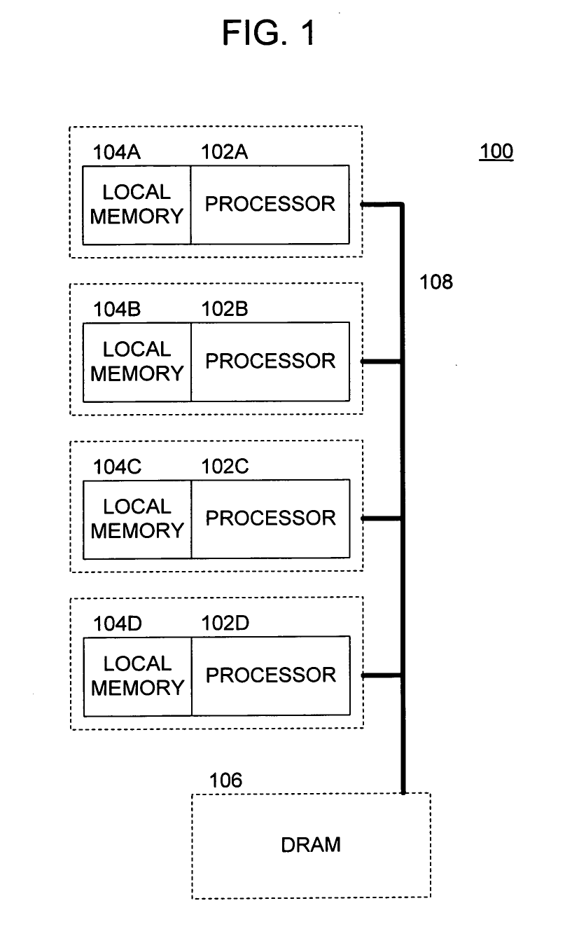

With reference to the drawings, wherein like numerals indicate like elements, there is shown in FIG. 1 a processing system 100 suitable for employing one or more aspects of the present invention. For the purposes of brevity and clarity, the block diagram of FIG. 1 will be referred to and described herein as illustrating an apparatus 100, it being understood, however, that the description may readily be applied to various aspects of a method with equal force.

The processing system 100 includes a plurality of processors 102A, 102B, 102C, and 102D, it being understood that any number of processors may be employed without departing from the spirit and scope of the invention. The processing system 100 also includes a plurality of local memories 104A, 104B, 104C, 104D and a shared memory 106. At least the processors 102, the local memories 104, and the shared memory 106 are preferably (directly or indirectly) coupled to one another over a bus system 108 that is operable to transfer data to and from each component in accordance with suitable protocols.

Each of the processors 102 may be of similar construction or of differing construction. The processors may be implemented utilizing any of the known technologies that are capable of requesting data from the shared (or system) memory 106, and manipulating the data to achieve a desirable result. For example, the processors 102 may be implemented using any of the known microprocessors that are capable of executing software and/or firmware, including standard microprocessors, distributed microprocessors, etc. By way of example, one or more of the processors 102 may be a graphics processor that is capable of requesting and manipulating data, such as pixel data, including gray scale information, color information, texture data, polygonal information, video frame information, etc.

One or more of the processors 102 of the system 100 may take on the role as a main (or managing) processor. The main processor may schedule and orchestrate the processing of data by the other processors.

The system memory 106 is preferably a dynamic random access memory (DRAM) coupled to the processors 102 through a memory interface circuit (not shown). Although the system memory 106 is preferably a DRAM, the memory 106 may be implemented using other means, e.g., a static random access memory (SRAM), a magnetic random access memory (MRAM), an optical memory, a holographic memory, etc.

Each processor 102 preferably includes a processor core and an associated one of the local memories 104 in which to execute programs. These components may be integrally disposed on a common semi-conductor substrate or may be separately disposed as may be desired by a designer. The processor core is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processor core may include an instruction buffer, instruction decode circuitry, dependency check circuitry, instruction issue circuitry, and execution stages.

Each local memory 104 is coupled to its associated processor core 102 via a bus and is preferably located on the same chip (same semiconductor substrate) as the processor core. The local memory 104 is preferably not a traditional hardware cache memory in that there are no on-chip or off-chip hardware cache circuits, cache registers, cache memory controllers, etc. to implement a hardware cache memory function. As on chip space is often limited, the size of the local memory may be much smaller than the shared memory 106.

The processors 102 preferably provide data access requests to copy data (which may include program data) from the system memory 106 over the bus system 108 into their respective local memories 104 for program execution and data manipulation. The mechanism for facilitating data access may be implemented utilizing any of the known techniques, for example the direct memory access (DMA) technique. This function is preferably carried out by the memory interface circuit.

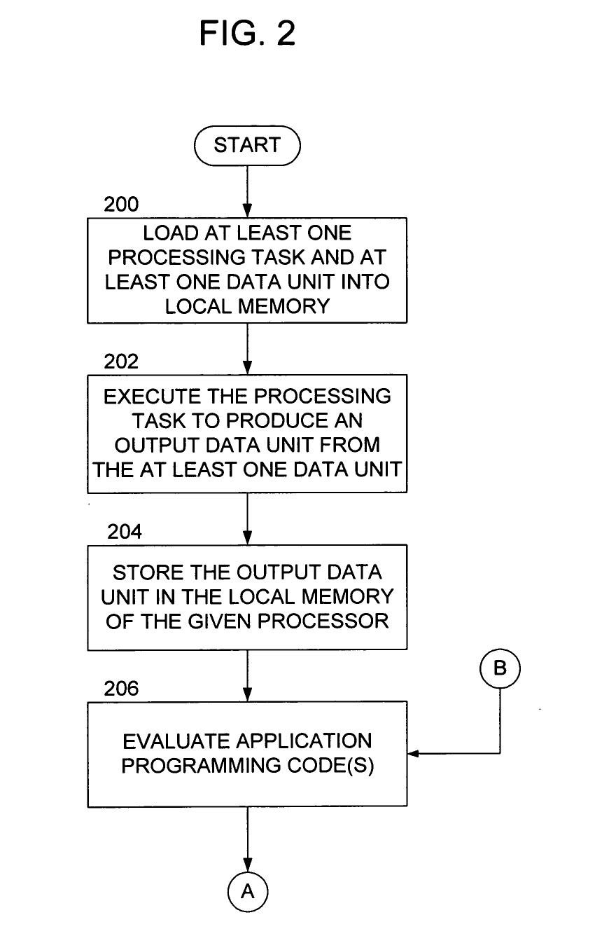

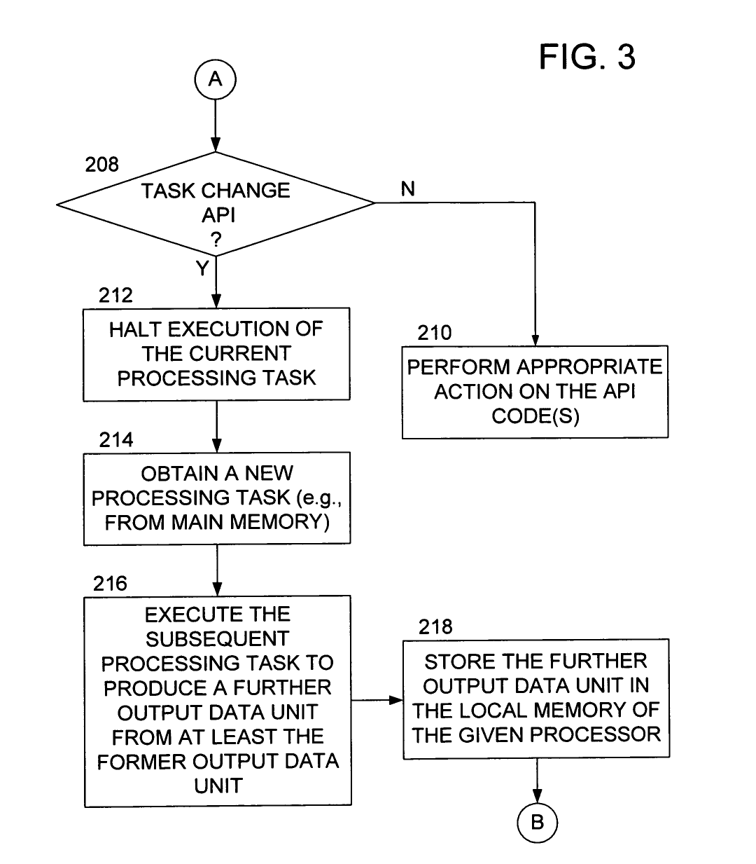

With reference to FIGS. 2-3, the processors 102 are preferably in operable communication with the system memory 106 in order to execute one or more software programs stored therein. The software programs may be formed of a number of processing tasks, where each processing task includes the execution of one or more instructions on data in order to achieve a result. The data may be considered to include a number of data units Un, where each data unit contains one or more data objects.

The processors 102 are preferably responsive to one or more application programming interface (API) codes to execute the processing tasks. For example, at action 200, at least one processing task is preferably loaded from the system memory 106 into the local memory 104 associated with a given processor 102. At action 202, the processor 102 executes the processing task to produce an output data unit (e.g., Un′) from the input data unit (e.g., Un). Thereafter, the output data unit is stored in the local memory 104 of the processor 102 (action 204).

In connection with the execution of the overall software program, at action 206 the processor 102 is preferably responsive to one or more API codes to change from the current processing task (from action 200) to a subsequent processing task. Further, the data unit utilized by the subsequent processing task is preferably the output data unit (e.g., Un′) from the current processing task, such that a further output data unit (e.g., Un″) is obtained within the processor 102.

In connection with the foregoing, at action 206, the processor 102 evaluates one or more API codes and makes a determination (at action 208) as to whether the API code or codes are task change API codes. If the result of the determination at action 208 is negative, then the process flow preferably advances to action 210, where appropriate action is taken on the given API codes. On the other hand, if the result of the determination action 208 is in the affirmative, then the process flow preferably advances to action 212, where execution of the current processing task is halted and a new processing task is obtained, such as from the system memory 106 (action 214).

Preferably, during the time that the current processing task is halted and the new subsequent processing task is obtained, the processor 102 is operable to maintain the output data unit (Un′) from the current processing task within the local memory 104 for later use by the subsequent processing task. In this regard, at action 216, the processor 102 preferably executes the subsequent processing task on the output data unit (Un′) from the previous processing task to produce a further output data unit (Un″). The further output data unit is preferably stored in the local memory 104 associated with the processor 102 (action 218). Thereafter, the process flow preferably returns to action 206, where further API codes are evaluated.

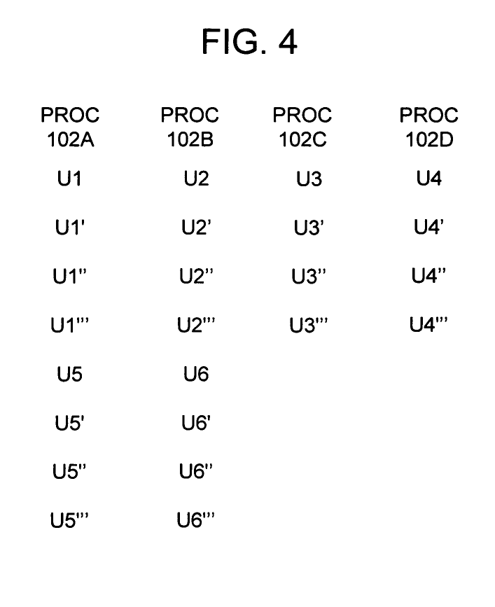

The process flow illustrated in FIGS. 2-3 is preferably repeated as needed such that all of the processing tasks of a given software program are executed on the data units in order to achieve an end result. By way of example, FIG. 4 illustrates a data parallel processing model that may be implemented and executed on the multi-processor system 100 of FIG. 1. In particular, the timing diagram of FIG. 4 illustrates the actions that are taken within the four processors 102A-D. In general, the software program may include M processing tasks for operating on N data units, where M and N are respective integer numbers. In the example illustrated in FIG. 4, M=4 (as there are four processing tasks), and N=6 (as there are six data units).

At a first time interval, data unit U1 is obtained by executing a first processing task within the processor 102A, data unit U2 is obtained by executing the first processing task within the processor 102B, data unit U3 is obtained by executing the first processor task within the processor 102C, and data unit U4 is obtained by executing the first processing task within the processor 102D. In accordance with the processing flow illustrated in FIGS. 2-3, the resultant output data units U1, U2, U3 and U4 are stored in the respective local memories 104 associated with the processors 102, respectively.

In response to one or more task change API codes, the respective processors 102 halt execution of the first processing task and obtain the second processing task for execution. In the second time interval, each of the processors execute the second processing task on the respective data units U1, U2, U3, and U4 in order to obtain further output data units U1′, U2′, U3′, and U4′. Thereafter, the processors 102 preferably respond to one or more further task change API codes by halting execution of the second processing task and obtaining the third processing task for execution. In the third time interval, each processor 102 preferably executes the third processing task on the respective output data units U1′, U2′, U3′, and U4′ in order to produce further output data units U1″, U2″, U3″, and U4″, respectively.

This process preferably repeats until all of the processing tasks have been executed on all of the data units Un. As illustrated in FIG. 4, further time intervals may be utilized to execute the four processing tasks within processors 102A and 102B in order to produce output data units U5′″ and U6′″. It is noted that when the one or more task change API codes indicate that the processing task should be changed, the output data unit from the previous processing task is preferably stored in the local memory 104 associated with the processor 102 for subsequent use in executing the subsequent processing task.

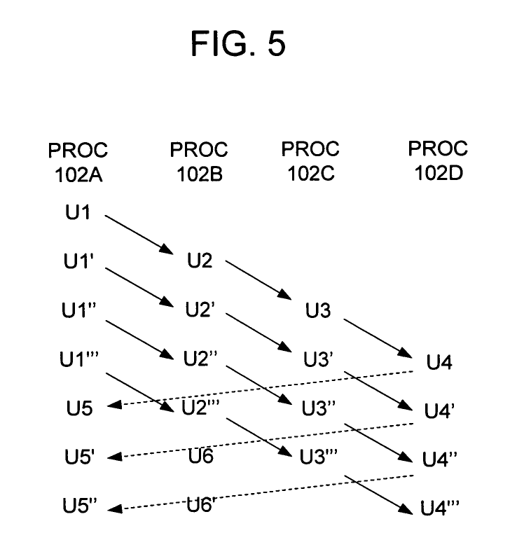

It is noted that the timing sequence illustrated in FIG. 4 is merely an example of many possible sequences in implementing a data parallel processing model. A further example of a timing sequence that may be carried out by the multi-processor system 100 of FIG. 1 is illustrated in FIG. 5. The sequence illustrated in FIG. 5, however, shows different data unit dependencies as compared with the dependencies in FIG. 4. In particular, in a first time interval output data unit U1 may be obtained by executing the first processing task on a given input data unit within the processor 102A. In a second time interval, the output data unit U1′ may be obtained by executing the second processing task on the data unit U1 within the processor 102A. Concurrently, the output data unit U1 may be utilized alone or in combination with other data to obtain the output data unit U2 by executing the first processing task in the processor 102B. In a third time interval, the output data unit U1″ may be obtained by executing the third processing task on the output data unit U1′ within the processor 102A. Concurrently, the output data unit U2′ may be obtained by executing the second processing task on the output data unit U1′ and/or the data unit U2 within the processor 102B. Still further, the output data unit U3 may be obtained by executing the first processing task on the data unit U2 alone or in combination with other data within the processor 102C.

This sequence preferably repeats until all processing tasks operate on all of the data units to achieve the desired result. The data units may be transferred between processors 102 as needed to achieve the dependency depicted in FIG. 5.

Preferably, the task change API codes may be invoked by the software programmer when he or she designs the software program. Through proper use of the task change API codes, the programmer may achieve a multi-processor system 100 that implements the data parallel processing model.

A description of a preferred computer architecture for a multi-processor system will now be provided that is suitable for carrying out one or more of the features discussed herein. In accordance with one or more embodiments, the multi-processor system may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system must complete tasks in a short and predictable time.

To this end, and in accordance with this computer architecture, all processors of a multi-processing computer system are constructed from a common computing module (or cell). This common computing module has a consistent structure and preferably employs the same instruction set architecture. The multi-processing computer system can be formed of one or more clients, servers, PCs, mobile computers, game machines, PDAs, set top boxes, appliances, digital televisions and other devices using computer processors.

A plurality of the computer systems may also be members of a network if desired. The consistent modular structure enables efficient, high speed processing of applications and data by the multi-processing computer system, and if a network is employed, the rapid transmission of applications and data over the network. This structure also simplifies the building of members of the network of various sizes and processing power and the preparation of applications for processing by these members.

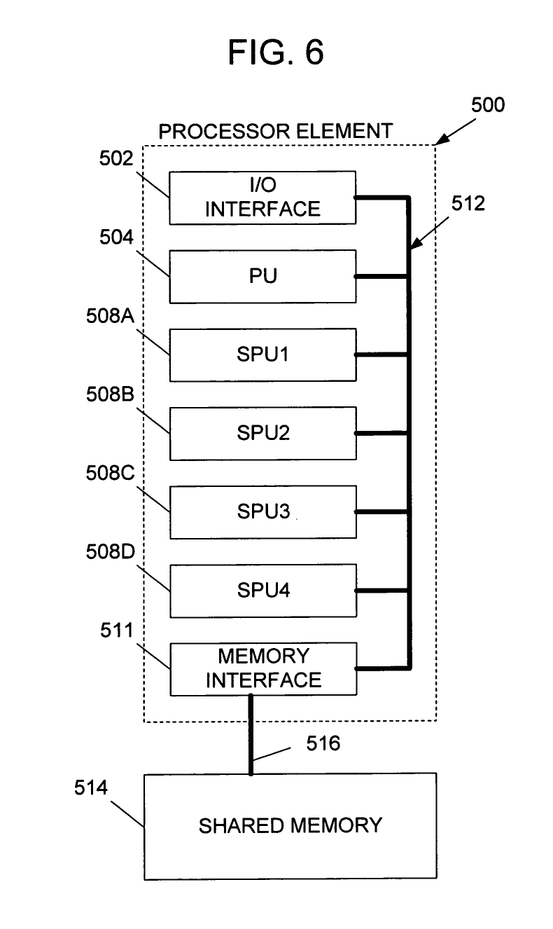

With reference to FIG. 6, the basic processing module is a processor element (PE) 500. The PE 500 comprises an I/O interface 502, a processing unit (PU) 504, and a plurality of sub-processing units 508, namely, sub-processing unit 508A, sub-processing unit 508B, sub-processing unit 508C, and sub-processing unit 508D. A local (or internal) PE bus 512 transmits data and applications among the PU 504, the sub-processing units 508, and a memory interface 511. The local PE bus 512 can have, e.g., a conventional architecture or can be implemented as a packet-switched network. If implemented as a packet switch network, while requiring more hardware, increases the available bandwidth.

The PE 500 can be constructed using various methods for implementing digital logic. The PE 500 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The PE 500 also may be implemented using superconducting material, e.g., rapid single-flux-quantum (RSFQ) logic.

The PE 500 is closely associated with a shared (main) memory 514 through a high bandwidth memory connection 516. Although the memory 514 preferably is a dynamic random access memory (DRAM), the memory 514 could be implemented using other means, e.g., as a static random access memory (SRAM), a magnetic random access memory (MRAM), an optical memory, a holographic memory, etc.

The PU 504 and the sub-processing units 508 are preferably each coupled to a memory flow controller (MFC) including direct memory access DMA functionality, which in combination with the memory interface 511, facilitate the transfer of data between the DRAM 514 and the sub-processing units 508 and the PU 504 of the PE 500. It is noted that the DMAC and/or the memory interface 511 may be integrally or separately disposed with respect to the sub-processing units 508 and the PU 504. Indeed, the DMAC function and/or the memory interface 511 function may be integral with one or more (preferably all) of the sub-processing units 508 and the PU 504. It is also noted that the DRAM 514 may be integrally or separately disposed with respect to the PE 500. For example, the DRAM 514 may be disposed off-chip as is implied by the illustration shown or the DRAM 514 may be disposed on-chip in an integrated fashion.

The PU 504 can be, e.g., a standard processor capable of stand-alone processing of data and applications. In operation, the PU 504 preferably schedules and orchestrates the processing of data and applications by the sub-processing units. The sub-processing units preferably are single instruction, multiple data (SIMD) processors. Under the control of the PU 504, the sub-processing units perform the processing of these data and applications in a parallel and independent manner. The PU 504 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PU 504 may be implemented by one of the sub-processing units 508 taking on the role of a main processing unit that schedules and orchestrates the processing of data and applications by the sub-processing units 508. Further, there may be more than one PU implemented within the processor element 500.

In accordance with this modular structure, the number of PEs 500 employed by a particular computer system is based upon the processing power required by that system. For example, a server may employ four PEs 500, a workstation may employ two PEs 500 and a PDA may employ one PE 500. The number of sub-processing units of a PE 500 assigned to processing a particular software cell depends upon the complexity and magnitude of the programs and data within the cell.

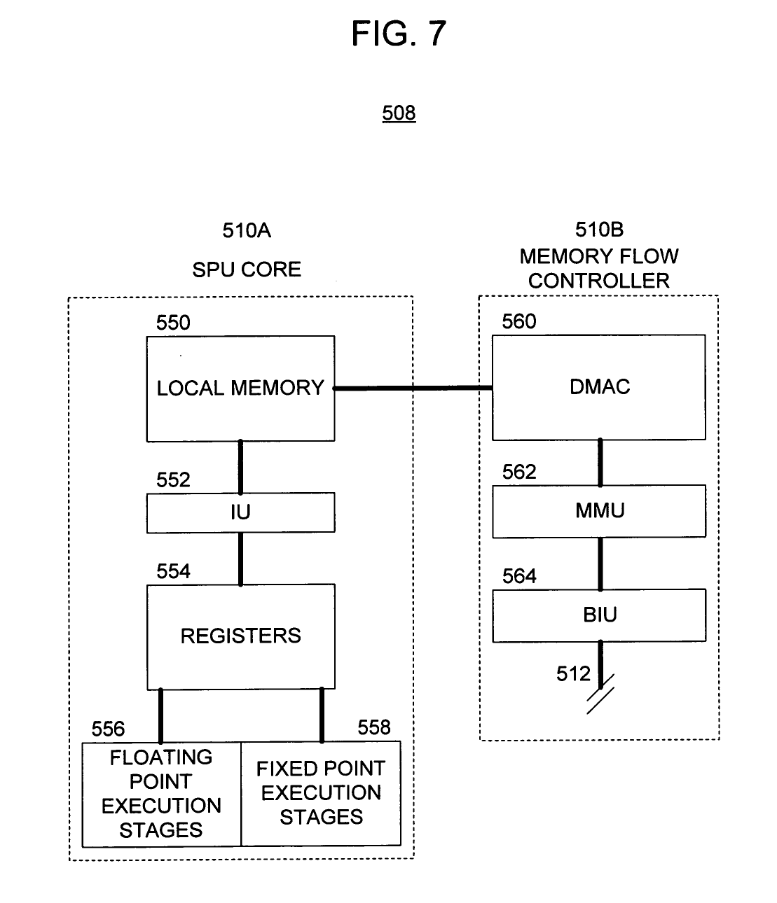

FIG. 7 illustrates the preferred structure and function of a sub-processing unit (SPU) 508. The SPU 508 architecture preferably fills a void between general-purpose processors (which are designed to achieve high average performance on a broad set of applications) and special-purpose processors (which are designed to achieve high performance on a single application). The SPU 508 is designed to achieve high performance on game applications, media applications, broadband systems, etc., and to provide a high degree of control to programmers of real-time applications. Some capabilities of the SPU 508 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The sub-processing unit 508 includes two basic functional units, namely an SPU core 510A and a memory flow controller (MFC) 510B. The SPU core 510A performs program execution, data manipulation, etc., while the MFC 510B performs functions related to data transfers between the SPU core 510A and the DRAM 514 of the system.

The SPU core 510A includes a local memory 550, an instruction unit (IU) 552, registers 554, one ore more floating point execution stages 556 and one or more fixed point execution stages 558. The local memory 550 is preferably implemented using single-ported random access memory, such as an SRAM. Whereas most processors reduce latency to memory by employing caches, the SPU core 510A implements the relatively small local memory 550 rather than a cache. Indeed, in order to provide consistent and predictable memory access latency for programmers of real-time applications (and other applications as mentioned herein) a cache memory architecture within the SPU 508A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 550 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the sub-processing units 508 references the associated local memory 550 using a local address, however, each location of the local memory 550 is also assigned a real address (RA) within the overall system's memory map. This allows Privilege Software to map a local memory 550 into the Effective Address (EA) of a process to facilitate DMA transfers between one local memory 550 and another local memory 550. The PU 504 can also directly access the local memory 550 using an effective address. In a preferred embodiment, the local memory 550 contains 556 kilobytes of storage, and the capacity of registers 552 is 128×128 bits.

The SPU core 504A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 552 includes an instruction buffer, instruction decode circuitry, dependency check circuitry, and instruction issue circuitry.

The instruction buffer preferably includes a plurality of registers that are coupled to the local memory 550 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 550, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously.

The instruction issue circuitry is operable to issue the instructions to the floating point execution stages 556 and/or the fixed point execution stages 558.

The registers 554 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU core 510A is of a superscalar architecture, such that more than one instruction is issued per clock cycle. The SPU core 510A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 556 and fixed point execution stages 558 may be employed. In a preferred embodiment, the floating point execution stages 556 operate at a speed of 32 billion floating point operations per second (32 GFLOPS), and the fixed point execution stages 558 operate at a speed of 32 billion operations per second (32 GOPS).

The MFC 510B preferably includes a bus interface unit (BIU) 564, a memory management unit (MMU) 562, and a direct memory access controller (DMAC) 560. With the exception of the DMAC 560, the MFC 510B preferably runs at half frequency (half speed) as compared with the SPU core 510A and the bus 512 to meet low power dissipation design objectives. The MFC 510B is operable to handle data and instructions coming into the SPU 508 from the bus 512, provides address translation for the DMAC, and snoop-operations for data coherency. The BIU 564 provides an interface between the bus 512 and the MMU 562 and DMAC 560. Thus, the SPU 508 (including the SPU core 510A and the MFC 510B) and the DMAC 560 are connected physically and/or logically to the bus 512.

The MMU 562 is preferably operable to translate effective addresses (taken from DMA commands) into real addresses for memory access. For example, the MMU 562 may translate the higher order bits of the effective address into real address bits. The lower-order address bits, however, are preferably untranslatable and are considered both logical and physical for use to form the real address and request access to memory. In one or more embodiments, the MMU 562 may be implemented based on a 64-bit memory management model, and may provide 2⁶⁴ bytes of effective address space with 4K-, 64K-, 1M-, and 16M- byte page sizes and 256 MB segment sizes. Preferably, the MMU 562 is operable to support up to 265 bytes of virtual memory, and 2⁴² bytes (4 TeraBytes) of physical memory for DMA commands. The hardware of the MMU 562 may include an 8-entry, fully associative SLB, a 256-entry, 4way set associative TLB, and a 4×4 Replacement Management Table (RMT) for the TLB—used for hardware TLB miss handling.

The DMAC 560 is preferably operable to manage DMA commands from the SPU core 510A and one or more other devices such as the PU 504 and/or the other SPUs. There may be three categories of DMA commands: Put commands, which operate to move data from the local memory 550 to the shared memory 514; Get commands, which operate to move data into the local memory 550 from the shared memory 514; and Storage Control commands, which include SLI commands and synchronization commands. The synchronization commands may include atomic commands, send signal commands, and dedicated barrier commands. In response to DMA commands, the MMU 562 translates the effective address into a real address and the real address is forwarded to the BIU 564.

The SPU core 510A preferably uses a channel interface and data interface to communicate (send DMA commands, status, etc.) with an interface within the DMAC 560. The SPU core 510A dispatches DMA commands through the channel interface to a DMA queue in the DMAC 560. Once a DMA command is in the DMA queue, it is handled by issue and completion logic within the DMAC 560. When all bus transactions for a DMA command are finished, a completion signal is sent back to the SPU core 510A over the channel interface.

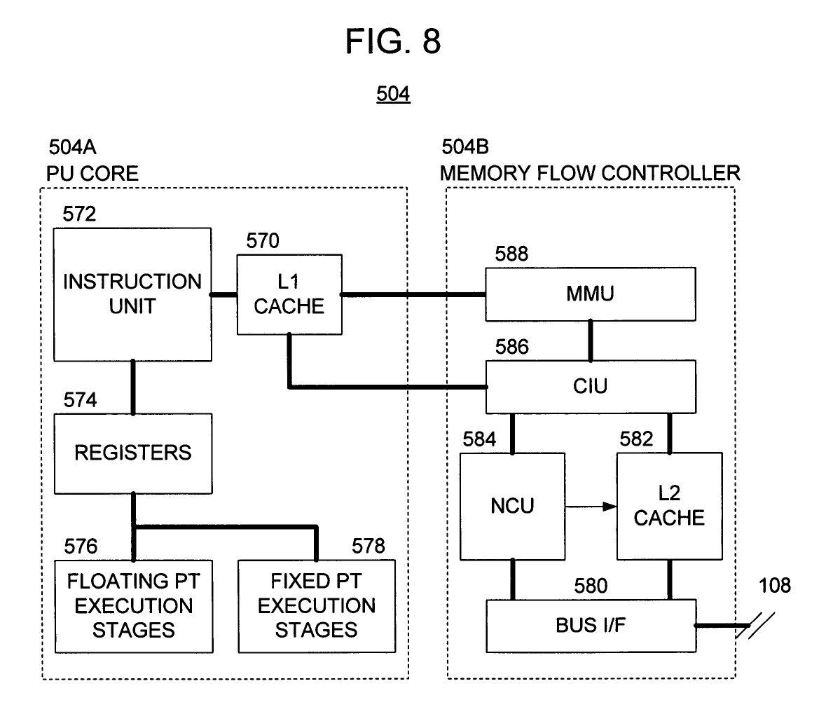

FIG. 8 illustrates the preferred structure and function of the PU 504. The PU 504 includes two basic functional units, the PU core 504A and the memory flow controller (MFC) 504B. The PU core 504A performs program execution, data manipulation, multi-processor management functions, etc., while the MFC 504B performs functions related to data transfers between the PU core 504A and the memory space of the system 100.

The PU core 504A may include an L1 cache 570, an instruction unit 572, registers 574, one or more floating point execution stages 576 and one or more fixed point execution stages 578. The L1 cache provides data caching functionality for data received from the shared memory 106, the processors 102, or other portions of the memory space through the MFC 504B. As the PU core 504A is preferably implemented as a superpipeline, the instruction unit 572 is preferably implemented as an instruction pipeline with many stages, including fetching, decoding, dependency checking, issuing, etc. The PU core 504A is also preferably of a superscalar configuration, whereby more than one instruction is issued from the instruction unit 572 per clock cycle. To achieve a high processing power, the floating point execution stages 576 and the fixed point execution stages 578 include a plurality of stages in a pipeline configuration. Depending upon the required processing power, a greater or lesser number of floating point execution stages 576 and fixed point execution stages 578 may be employed.

The MFC 504B includes a bus interface unit (BIU) 580, an L2 cache memory, a non-cachable unit (NCU) 584, a core interface unit (CIU) 586, and a memory management unit (MMU) 588. Most of the MFC 504B runs at half frequency (half speed) as compared with the PU core 504A and the bus 108 to meet low power dissipation design objectives.

The BIU 580 provides an interface between the bus 108 and the L2 cache 582 and NCU 584 logic blocks. To this end, the BIU 580 may act as a Master as well as a Slave device on the bus 108 in order to perform fully coherent memory operations. As a Master device it may source load/store requests to the bus 108 for service on behalf of the L2 cache 582 and the NCU 584. The BIU 580 may also implement a flow control mechanism for commands which limits the total number of commands that can be sent to the bus 108. The data operations on the bus 108 may be designed to take eight beats and, therefore, the BIU 580 is preferably designed around 128 byte cache-lines and the coherency and synchronization granularity is 128 KB.

The L2 cache memory 582 (and supporting hardware logic) is preferably designed to cache 512 KB of data. For example, the L2 cache 582 may handle cacheable loads/stores, data pre-fetches, instruction fetches, instruction pre-fetches, cache operations, and barrier operations. The L2 cache 582 is preferably an 8-way set associative system. The L2 cache 582 may include six reload queues matching six (6) castout queues (e.g., six RC machines), and eight (64-byte wide) store queues. The L2 cache 582 may operate to provide a backup copy of some or all of the data in the L1 cache 570. Advantageously, this is useful in restoring state(s) when processing nodes are hot-swapped. This configuration also permits the L1 cache 570 to operate more quickly with fewer ports, and permits faster cache-to-cache transfers (because the requests may stop at the L2 cache 582). This configuration also provides a mechanism for passing cache coherency management to the L2 cache memory 582.

The NCU 584 interfaces with the CIU 586, the L2 cache memory 582, and the BIU 580 and generally functions as a queueing/buffering circuit for non-cacheable operations between the PU core 504A and the memory system. The NCU 584 preferably handles all communications with the PU core 504A that are not handled by the L2 cache 582, such as cache-inhibited load/stores, barrier operations, and cache coherency operations. The NCU 584 is preferably run at half speed to meet the aforementioned power dissipation objectives.

The CIU 586 is disposed on the boundary of the MFC 504B and the PU core 504A and acts as a routing, arbitration, and flow control point for requests coming from the execution stages 576, 578, the instruction unit 572, and the MMU unit 588 and going to the L2 cache 582 and the NCU 584. The PU core 504A and the MMU 588 preferably run at full speed, while the L2 cache 582 and the NCU 584 are operable for a 2:1 speed ratio. Thus, a frequency boundary exists in the CIU 586 and one of its functions is to properly handle the frequency crossing as it forwards requests and reloads data between the two frequency domains.

The CIU 586 is comprised of three functional blocks: a load unit, a store unit, and reload unit. In addition, a data pre-fetch function is performed by the CIU 586 and is preferably a functional part of the load unit. The CIU 586 is preferably operable to: (i) accept load and store requests from the PU core 504A and the MMU 588; (ii) convert the requests from full speed clock frequency to half speed (a 2:1 clock frequency conversion); (iii) route cachable requests to the L2 cache 582, and route non-cachable requests to the NCU 584; (iv) arbitrate fairly between the requests to the L2 cache 582 and the NCU 584; (v) provide flow control over the dispatch to the L2 cache 582 and the NCU 584 so that the requests are received in a target window and overflow is avoided; (vi) accept load return data and route it to the execution stages 576, 578, the instruction unit 572, or the MMU 588; (vii) pass snoop requests to the execution stages 576, 578, the instruction unit 572, or the MMU 588; and (viii) convert load return data and snoop traffic from half speed to full speed.

The MMU 588 preferably provides address translation for the PU core 540A, such as by way of a second level address translation facility. A first level of translation is preferably provided in the PU core 504A by separate instruction and data ERAT (effective to real address translation) arrays that may be much smaller and faster than the MMU 588.

In a preferred embodiment, the PU 504 operates at 4-6 GHz, 10F04, with a 64-bit implementation. The registers are preferably 64 bits long (although one or more special purpose registers may be smaller) and effective addresses are 64 bits long. The instruction unit 570, registers 572 and execution stages 574 and 576 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Advantageously, various aspects of the present invention enable a software programmer to cause a multi-processor system to respond to one or more task change API codes and exhibit the data parallel processing model.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus, comprising: a plurality of processors capable of operable communication with a main memory to execute one or more software programs in accordance with a data parallel processing model, the software programs being comprised of a number of processing tasks, each task executing instructions on one or more input data units to produce an output data unit, and each data unit containing one or more data objects, wherein the processors are responsive to one or more application programming interface codes to change from a current processing task to a subsequent processing task such that the output data unit produced by the current processor task may be used as an input data unit by the subsequent processing task to produce a further output data unit within the same processor.

2. The apparatus of claim 1, wherein the application programming interface codes may be invoked by a software programmer when he designs the one or more software programs such that the plurality of processors implement the data parallel processing model.

3. The apparatus of claim 1, wherein the software application dictates that the processing tasks are executed repeatedly on different data units to achieve an end result.

4. The apparatus of claim 3, wherein the certain of the data units are dependent on one or more others of the data units.

5. The apparatus of claim 1, wherein:
each processor includes a local memory within which to execute the processing tasks without resort to the main memory; and
the processors are responsive to the application programming interface code(s) to change from the current processing task to the subsequent processing task while maintaining the output data unit from the current processing task within the local memory of the given processor.

6. The apparatus of claim 5, wherein the processors are responsive to a request to copy the output data unit from the current processing task to another processor for use as an input data unit for a different processing task.

7. The apparatus of claim 5, wherein:
the software program includes M processing tasks for operating on N data units, where M and N are respective integer numbers;
a first of the processors is operable to execute a first of the processing tasks on at least a first of the data units to produce a first output data unit therefrom for storage in the local memory thereof;
the first of the processors is operable to change from the first processor task to a second processor task and to operate on at least the first output data unit to produce a second output data unit therefrom for storage in the local memory thereof in response to the application programming interface code(s); and
the first processor is operable to repeat these operations until the M processing tasks have been performed on the first data unit.

8. The apparatus of claim 7, wherein:
a second of the processors is operable to execute a first of the processing tasks on at least a second of the data units to produce a first output data unit therefrom for storage in the local memory thereof, concurrently with the operation of the first processor;
the second of the processors is operable to change from the first processor task to the second processor task and to operate on at least the first output data unit to produce a second output data unit therefrom for storage in the local memory thereof in response to the application programming interface code(s); and
the second processor is operable to repeat these operations until the M processing tasks have been performed on the second data unit.

9. The apparatus of claim 8, wherein one or more of the further processors are operable to sequentially execute the M processing tasks on the data units until all of the M processing tasks have been performed on all of the N data units.

10. A method, comprising:
executing one or more software programs within a plurality of processors of a multi-processing system in accordance with a data parallel processing model, the software programs being comprised of a number of processing tasks, each task executing instructions on one or more input data units to produce an output data unit, and each data unit containing one or more data objects;
responding to one or more application programming interface codes to change from a current processing task to a subsequent processing task within a given one or more of the processors; and
using the output data unit produced by the current processor task as an input data unit by the subsequent processing task to produce a further output data unit within the same processor.

11. The method claim 10, wherein the application programming interface codes may be invoked by a software programmer when he designs the one or more software programs such that the plurality of processors implement the data parallel processing model.

12. The method of claim 10, wherein the software application dictates that the processing tasks are executed repeatedly on different data units to achieve an end result.

13. The method of claim 12, wherein certain of the data units are dependent on one or more others of the data units.

14. The method of claim 10, wherein:
each processor includes a local memory within which to execute the processing tasks without resort to the main memory; and
the method further includes responding to the application programming interface code(s) to change from the current processing task to the subsequent processing task within a given processor while maintaining the output data unit from the current processing task within the local memory of the given processor.

15. The method of claim 14, further comprising responding to a request to copy the output data unit from the current processing task to another processor for use as an input data unit for a different processing task.

16. The method of claim 14, wherein the software program includes M processing tasks for operating on N data units, where M and N are respective integers, and the method further comprises:
executing a first of the processing tasks on at least a first of the data units to produce a first output data unit therefrom for storage in the local memory of a first of the processors;
changing from the first processor task to a second processor task for operating on at least the first output data unit to produce a second output data unit therefrom for storage in the local memory of the first of the processors in response to the application programming interface code(s); and
repeating these operations until the M processing tasks have been performed on the first data unit in the first processor.

17. The method of claim 16, further comprising:
executing a first of the processing tasks on at least a second of the data units to produce a first output data unit therefrom for storage in the local memory of a second of the processors, concurrently with the operation of the first processor;
changing from the first processor task to the second processor task and operating on at least the first output data unit to produce a second output data unit therefrom for storage in the local memory of the second of the processors in response to the application programming interface code(s); and
repeating these operations until the M processing tasks have been performed on the second data unit in the second processor.

18. The method of claim 17, further comprising sequentially executing the M processing tasks on the data units until all of the M processing tasks have been performed on all of the N data units in one or more of the further processors.

19. A storage medium containing software code operable to cause one or more of a plurality of processors of a multi-processing system to execute actions, comprising:
executing one or more software programs in accordance with a data parallel processing model, the software programs being comprised of a number of processing tasks, each task executing instructions on one or more input data units to produce an output data unit, and each data unit containing one or more data objects;
responding to one or more application programming interface codes to change from a current processing task to a subsequent processing task within a given one or more of the processors; and
using the output data unit produced by the current processor task as an input data unit by the subsequent processing task to produce a further output data unit within the same processor.

20. The storage medium claim 19, wherein the application programming interface codes may be invoked by a software programmer when he designs the one or more software programs such that the plurality of processors implement the data parallel processing model.

21. The storage medium of claim 19, wherein the software application dictates that the processing tasks are executed repeatedly on different data units to achieve an end result.

22. The storage medium of claim 21, wherein certain of the data units are dependent on one or more others of the data units.

23. The storage medium of claim 19, wherein:
each processor includes a local memory within which to execute the processing tasks without resort to the main memory; and
the method further includes responding to the application programming interface code(s) to change from the current processing task to the subsequent processing task within a given processor while maintaining the output data unit from the current processing task within the local memory of the given processor.

24. The storage medium of claim 23, further comprising responding to a request to copy the output data unit from the current processing task to another processor for use as an input data unit for a different processing task.

25. The storage medium of claim 23, wherein the software program includes M processing tasks for operating on N data units, where M and N are respective integers, and the method further comprises:
executing a first of the processing tasks on at least a first of the data units to produce a first output data unit therefrom for storage in the local memory of a first of the processors;
changing from the first processor task to a second processor task for operating on at least the first output data unit to produce a second output data unit therefrom for storage in the local memory of the first of the processors in response to the application programming interface code(s); and
repeating these operations until the M processing tasks have been performed on the first data unit in the first processor.

26. The storage medium of claim 25, further comprising:
executing a first of the processing tasks on at least a second of the data units to produce a first output data unit therefrom for storage in the local memory of a second of the processors, concurrently with the operation of the first processor;
changing from the first processor task to the second processor task and operating on at least the first output data unit to produce a second output data unit therefrom for storage in the local memory of the second of the processors in response to the application programming interface code(s); and
repeating these operations until the M processing tasks have been performed on the second data unit in the second processor.

27. The storage medium of claim 26, further comprising sequentially executing the M processing tasks on the data units until all of the M processing tasks have been performed on all of the N data units in one or more of the further processors.

28. A system comprising:
a shared memory;
a plurality of processors operatively coupled to the shared memory to execute one or more software programs in accordance with a data parallel processing model, the software programs being comprised of a number of processing tasks, each task executing instructions on one or more input data units to produce an output data unit, and each data unit containing one or more data objects; and
a local memory associated with each processor in which to execute the processing tasks without resort to the shared memory,
wherein the processors are responsive to one or more application programming interface codes to change from a current processing task to a subsequent processing task such that the output data unit produced by the current processor task may be used as an input data unit by the subsequent processing task to produce a further output data unit within the same processor.

29. The system of claim 28, wherein the processors are responsive to the application programming interface code(s) to change from the current processing task to the subsequent processing task while maintaining the output data unit from the current processing task within the local memory of the given processor.

30. The system of claim 28, wherein the processors are fabricated on a common semiconductor substrate.

31. The system of claim 30, wherein the processors and the local memories are fabricated on a common semiconductor substrate.

32. The system of claim 30, wherein the local memories are not hardware cache memories.

33. The system of claim 28, wherein the processors, the local memories, and the shared memory are fabricated on a common semiconductor substrate.
